(19) United States
(12) Patent Application Publication
(10) Pub. No.: US 2026/0264630 A1
(43) Pub. Date: Sep. 10, 2026

(54) METHOD FOR CONTROLLING CONSOLE FOR VEHICLE

(71) Applicants: Hyundai Motor Company, Seoul (KR); Kia Corporation, Seoul (KR); ECOPLASTIC CORPORATION, Gyeongju-si (KR)

(72) Inventors: Min Ha LEE, Hwaseong-Si (KR); Hee Dong CHOI, Hwaseong-Si (KR); Seok Ju GIM, Hwaseong-Si (KR); Mu Young KIM, Hwaseong-Si (KR); Hee Sang PARK, Hwaseong-Si (KR); Sang Woo KIM, Hwaseong-Si (KR); Jong Heon LEE, Suwon-si (KR); Hae Ju PARK, Gyeongju-si (KR)

(21) Appl. No.: 19/406,008

(22) Filed: Dec. 2, 2025

(30) Foreign Application Priority Data
Mar. 10, 2025 (KR) 10-2025-0030870

(51) Int. Cl. B60R 16/023; B60R 7/04; B60K 35/10; B60N 2/01; B60N 2/14

(52) U.S. Cl. CPC B60R 16/0231; B60R 7/04; B60K 35/10; B60K 2360/1446; B60K 2360/345; B60N 2/01; B60N 2/14

(57) ABSTRACT

Disclosed is a method for controlling a console for a vehicle. The method may include: receiving, via a switch on a console of the vehicle, a console operation input; and controlling the console to move, between a deployed position and a stowed position, based on the console operation input and based on: a gear position of the vehicle being a park position, a seat of the vehicle not being in an ingress and egress assist mode, the seat not being in a face-to-face mode, in which the seat is rotated to face another seat of the vehicle, and a display of the vehicle being turned off.

### CROSS-REFERENCE TO RELATED APPLICATION

This application claims the benefit of and priority to Korean Patent Application No. 10-2025-0030870, filed in the Korean Intellectual Property Office on March 10, 2025, the entire contents of which are incorporated herein by reference.

### TECHNICAL FIELD

The present disclosure relates to a method for controlling a console of a vehicle.

### BACKGROUND

A console of a vehicle may be used as an apparatus that is installed in a position that is easily approached by the driver in an interior of the vehicle to store articles or provide various functions. The vehicle console of a vehicle may be provided with, for example, a cup holder, a charging area for a smartphone, a charging port, one or more buttons, and various other convenience functions.

Vehicle consoles may be provided in a fixed form to provide convenience for drivers or passengers. However, with the development of autonomous vehicles that do not require direct control of the vehicle by the driver at all times, a need for a structure that may flexibly utilize a space in an interior of the autonomous vehicle is increasing.

Accordingly, research and development is active on vehicle consoles with options for more versatility in placement and position.

The matters described in this Background section are only for enhancement of understanding of the background of the disclosure, and should not be taken as acknowledgement that they correspond to prior art already known to those skilled in the art.

### SUMMARY

The present disclosure has been made to solve problems occurring in at least some implementations while advantages achieved by those implementations are maintained intact.

An aspect of the present disclosure provides a method for controlling a console of a vehicle, a position of which may be changed in an interior of the vehicle.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a method performed by an apparatus may include: receiving, via a switch on a console of the vehicle, a console operation input; and controlling the console to move, between a deployed position and a stowed position, based on the console operation input and based on: a gear position of the vehicle being a park position, a seat of the vehicle not being in an ingress and egress assist mode, the seat not being in a face-to-face mode, in which the seat is rotated to face another seat of the vehicle, and a display of the vehicle being turned off.

The deployed position of the console may be more rearward and higher relative to the stowed position of the console.

The method may further include: determining, based on a height of the console and a longitudinal position of the console, whether the console is in the deployed position.

The switch may include a touch-sensitive button configured to control the console to move from one of the deployed position or the stowed position to another one of the deployed position or the stowed position. Controlling the console may include one of: controlling, based on the console operation input via the touch-sensitive button being received and the console being in the deployed position, the console to move from the deployed position to the stowed position; or controlling, based on the console operation input being received and the console being in the stowed position, the console to move from the stowed position to the deployed position.

Controlling the console may include: controlling, based on the console operation input via the touch-sensitive button being received and the console being in the deployed position, the console to move forward from the deployed position to a first intermediate position while maintaining a first height of the console for the vehicle; controlling the console to move from the first intermediate position to a second intermediate position while maintaining the console at a first angle; and controlling the console to move from the second intermediate position to the stowed position while maintaining a second height of the console. The first angle may be between a longitudinal axis of the vehicle and a first vector directed toward a lower forward direction of the vehicle.

The first angle may correspond to an angle of a slope of a tangent line touching a surface of a dashboard module and extending from a point of the stowed position located below the dashboard module.

Controlling the console may include: controlling, based on the console operation input being received and the console being in the stowed position, the console to move rearward from the stowed position to the second intermediate position while maintaining the second height of the console; controlling the console to move from the second intermediate position to the first intermediate position while maintaining the console at a second angle; and controlling the console to move rearward from the first intermediate position to the deployed position while maintaining the first height of the console. The second angle may be between the longitudinal axis of the vehicle and a second vector directed toward an upper rear direction.

The first vector and the second vector may be antiparallel vectors.

Controlling the console may include: controlling, based on the console operation input being received and the console being located in front of an imaginary line that extends from the deployed position at the first angle, the console to move to a third intermediate position having a same height as the deployed position while maintaining the console at the second angle with respect to the upper rear direction; and controlling the console to move rearward from the third intermediate position to the deployed position while maintaining the console at the first height.

Controlling the console may include: controlling, based on the console operation input being received and the console being located in rear of the imaginary line that extends from the deployed position at the first angle, the console to move to a fourth intermediate position while maintaining the console at the second angle with respect to the upper rear direction; and controlling the console to move upward from the fourth intermediate position to the deployed position.

The switch may include an up button and a down button. Controlling the console may include one of: controlling, based on the up button being pushed, the console to move up; or controlling, based on the down button being pushed, the console to move down.

Controlling the console may further include: preventing, based on the up button being pushed and the console reaching a same height as the deployed position, the console from moving any further up; or preventing, based on the down button being pushed and the console reaching a same height as the stowed position, the console from moving any further down.

The switch may include a forward button and a rearward button. Controlling the console may include one of: controlling, based on the forward button being pushed, the console to move forward; or controlling, based on the rearward button being pushed, the console to move rearward.

Controlling the console may further include: preventing, based on the forward button being pushed and the console reaching a same longitudinal position as the stowed position, the console from moving any further forward; or preventing, based on the rearward button being pushed and the console reaching a same longitudinal position as the deployed position, the console from moving any further rearward.

Controlling the console may include: controlling the console to move further based on: each of a pair of front seats of the vehicle having a swivel angle, relative to a front-facing longitudinal direction of the vehicle, of 3 degrees or less.

The switch may include: an up button configured to control the console to move up; a down button configured to control the console to move down; a forward button configured to control the console to move forward; a rearward button configured control the console to move rearward; and a plurality of lamps, each of the plurality of lamps provided on a lower portion of each of the up button, the down button, the forward button, and the rearward button. Controlling the console may include: controlling, based on one of the up button, the down button, the forward button, or the rearward button being pushed, a corresponding lamp of the plurality of lamps to switch on.

According to one or more example embodiments of the present disclosure, an apparatus of a vehicle may include: a console including a switch configured to receive a console operation input; and control circuitry configured to: control the console to move, between a deployed position and a stowed position, based on the console operation input and based on: a gear position of the vehicle being a parking position, a seat of the vehicle not being in an ingress and egress assist mode, the seat not being in a face-to-face mode, in which the seat is rotated to face another seat of the vehicle, and a display of the vehicle being turned off.

The deployed position of the console may be more rearward and higher relative to the stowed position of the console.

The control circuitry may be configured to: determine, based on a height of the console and a longitudinal position of the console, whether the console is in the deployed position.

### BRIEF DESCRIPTION OF THE DRAWINGS

The above and other aspects, features and advantages of the present disclosure will be more apparent from the following detailed description taken in conjunction with the accompanying drawings:

FIG. 1 is a schematic view of an example vehicle;

FIG. 2 is a view of example console switches;

FIG. 3 is a flowchart of an example method for controlling an example console of a vehicle;

FIGS. 4, 5, and 6 are flowcharts for an example method of controlling a console of a vehicle;

FIG. 7 is a view illustrating an example of a reference state of a front seat;

FIG. 8 is a side view of an example vehicle console that transitions from a standard position to a collapsed position, along with a dashboard module and a front seat;

FIG. 9 is a view illustrating a movement path of an example console of a vehicle;

FIG. 10 is a side view of an example vehicle console that transitions from a collapsed position to a standard position, along with a dashboard module and a front seat;

FIG. 11 is a view illustrating a movement path of an example console of a vehicle;

FIG. 12 is a side view of an example vehicle console that transitions from a second area to a standard position, along with a dashboard module and a front seat;

FIG. 13 is a view illustrating a movement path of an example console a vehicle;

FIG. 14 is a side view of an example vehicle of that transitions from a third area to a standard position, along with a dashboard module and a front seat; and

FIG. 15 is a view illustrating a movement path of an example console of a vehicle.

FIG. 16 shows an example computing system.

### DETAILED DESCRIPTION

Hereinafter, one or more example embodiments of the present disclosure will be described in detail with reference to the accompanying drawings. In adding reference numerals to the components of the drawings, it should be noted that the same components have the same numerals as possible even when they are illustrated on different drawings. Furthermore, in describing the example embodiment(s) of the present disclosure, detailed descriptions associated with well-known functions or configurations will be omitted if they may make subject matters of the present disclosure unnecessarily obscure.

In describing components of the example embodiment(s) of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

Unless otherwise defined, the terms used herein, including technical or scientific terms, may have meanings generally understood by those skilled in the art to which the present disclosure belongs.

The expressions such as “comprise,” “may comprise,” “include,” “may include,” “have,” “may have,” etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip,” “second chip,” respectively.

The term “unit” as used herein may refer to software, or hardware component such as Field-Programmable Gate Array (FPGA), Application Specific Integrated Circuit (ASIC), etc. However, “unit” is not limited to hardware and software. The “unit" may be configured to be stored in an addressable storage medium, or may be configured to execute one or more processors. The "unit" may include components such as software components, object-oriented software components, class components, and task components, as well as processors, functions, attributes, procedures, subroutines, segments of program code, drivers, firmware, microcode, circuits, data, databases, data structures, tables, arrays, and variables.

The expression “based” on as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to,” “with the ability to,” “modified to,” “made to,” “to be able to,” etc. This expression is not limited to the meaning of “specially designed in hardware to.” For example, a processor configured to perform a specific operation may refer to a generic purpose processor capable of performing the specific operation by executing software, or to a special purpose computer structured through programming to perform the specific operation.

As described herein, a first direction (e.g., the “X” direction as indicated in the drawings) may correspond to a forward direction. An object facing in the first direction may be referred to as facing “forward.” An object located further along the first direction, in relative terms, may be described as being “front.” The opposite direction of the first direction (e.g., the opposite direction of the “X” direction as indicated in the drawings) may correspond to a “backward” or “rearward” direction. An object facing in the opposite direction of the first direction may be referred to as facing “backward.” An object located further along the opposite direction of the first direction, in relative terms, may be described as being “rear.” A second direction (e.g., the “Y” direction as indicated in the drawings) may correspond to a leftward direction. An object facing in the second direction may be referred to as facing “left.” An object located further along the second direction, in relative terms, may be described as being “left.” The opposite direction of the second direction (e.g., the opposite direction of the “Y” direction as indicated in the drawings) may correspond to a rightward direction. An object facing in the opposite direction of the second direction may be referred to as facing “rightward.” An object located further along the opposite direction of the first direction, in relative terms, may be described as being “right.” A third direction (e.g., the “Z” direction as indicated in the drawings) may correspond to an upward direction. An object facing in the third direction may be referred to as facing “upward.” An object located further along the third direction, in relative terms, may be described as being “up” or “top.” The opposite direction of the third direction (e.g., the opposite direction of the “Z” direction as indicated in the drawings) may correspond to a “downward” direction. An object located further along the opposite direction of the third direction, in relative terms, may be described as being “down” or bottom.” Further, each of the first direction, the second direction, and the third direction may be perpendicular (e.g., orthogonal) to the remaining two directions. The first direction (or the opposite direction thereof) may be also referred to as the longitudinal direction or longitudinal orientation. The second direction (or the opposite direction thereof) may be also referred to as the lateral direction or lateral orientation. The third direction (or the opposite direction thereof) may be also referred to as the vertical direction or vertical orientation.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., monitoring various component states of a vehicle and operation inputs) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., monitoring various component states of a vehicle and operation inputs) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., monitoring various component states of a vehicle and operation inputs) described herein.

Minimum risk maneuver (MRM) operation(s) may also be controlled, for example, based on one or more features (e.g., monitoring various component states of a vehicle and operation inputs) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., monitoring various component states of a vehicle and operation inputs) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., monitoring various component states of a vehicle and operation inputs) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as 5 seconds, 30 seconds, 1 minute, etc.). By changing the required user attentiveness, the driver may be required to look ahead more often (e.g., at least once in a threshold time period, such as 5 seconds, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., monitoring various component states of a vehicle and operation inputs) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). One or more auxiliary devices (e.g., engine brake, exhaust brake, hydraulic retarder, electric retarder, regenerative brake, etc.) may also be controlled, for example, based on one or more features (e.g., monitoring various component states of a vehicle and operation inputs) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein. An operation control may also include, for example, moving a console of the vehicle (e.g., between a deployed position and a stowed position).

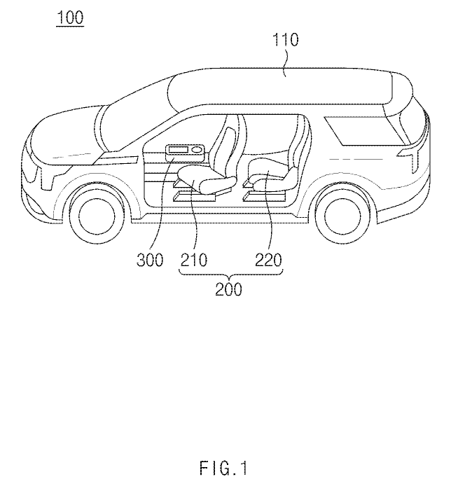

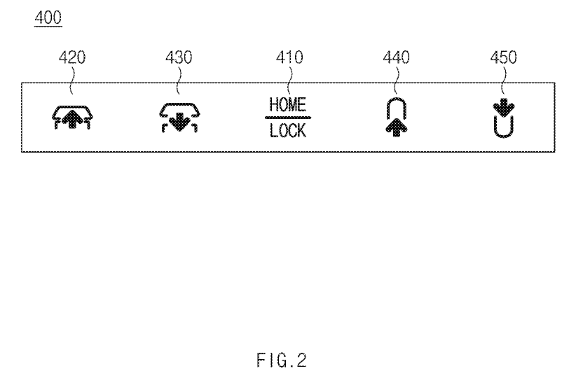

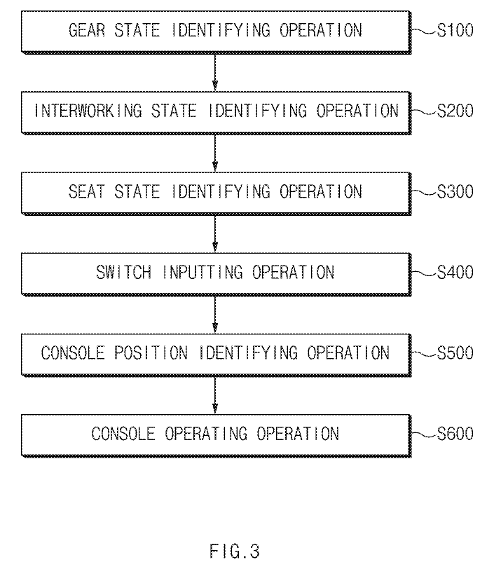

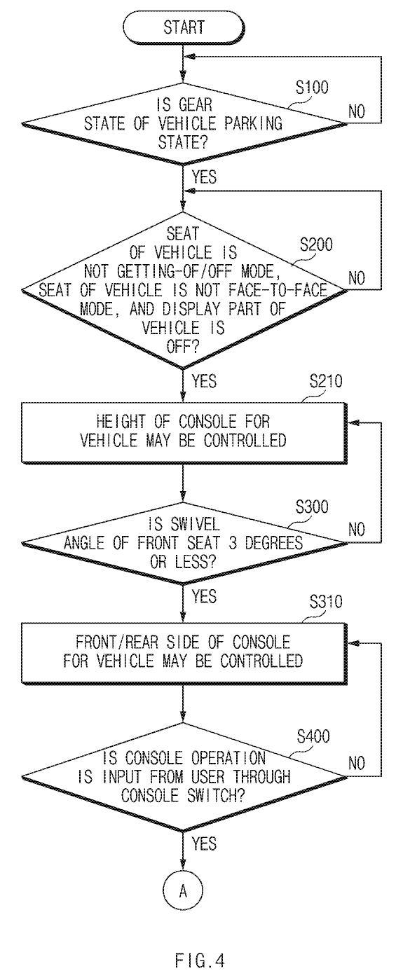

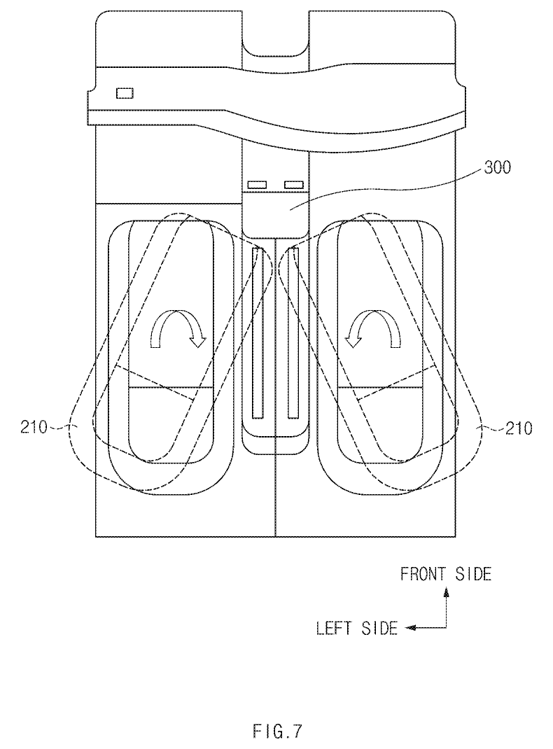

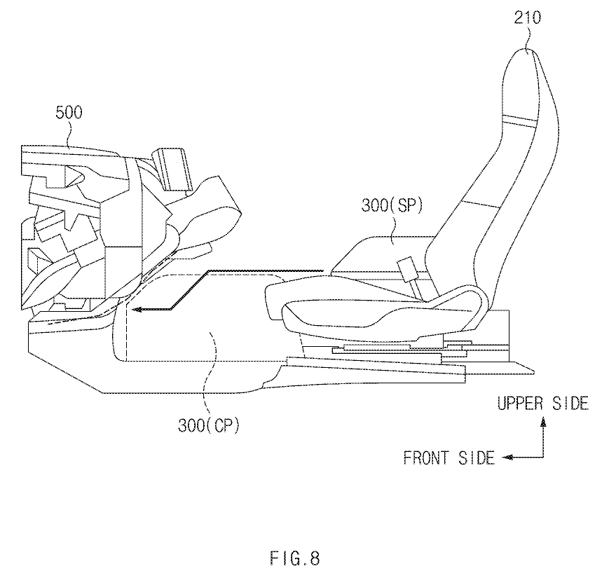

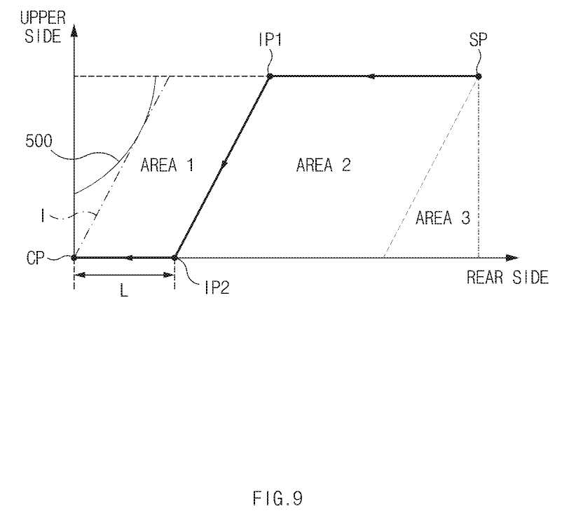

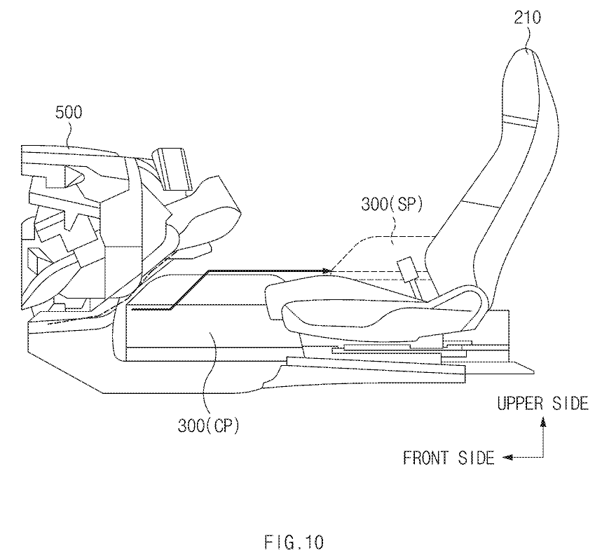

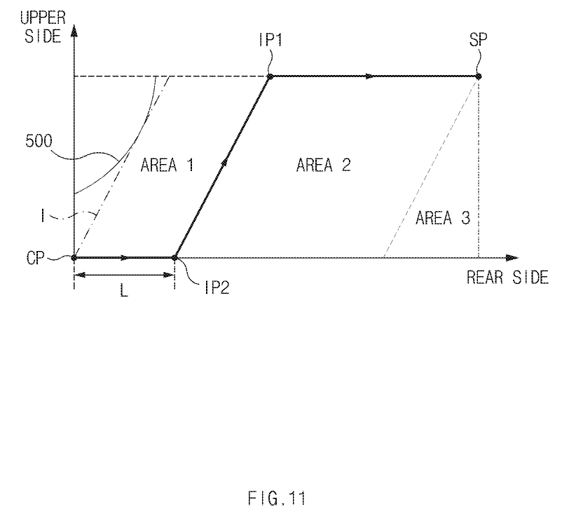

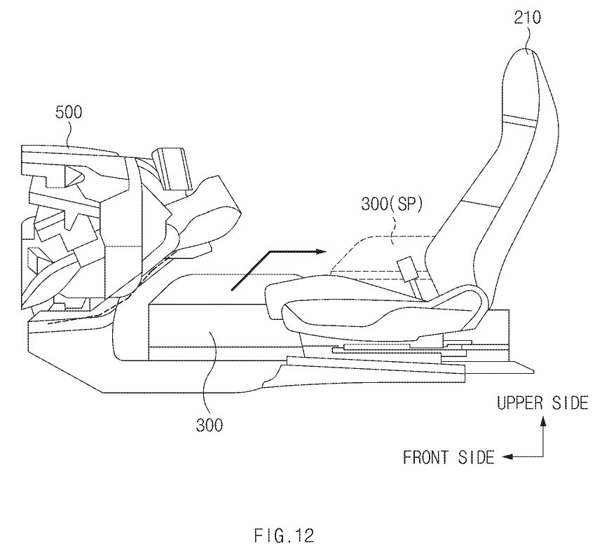

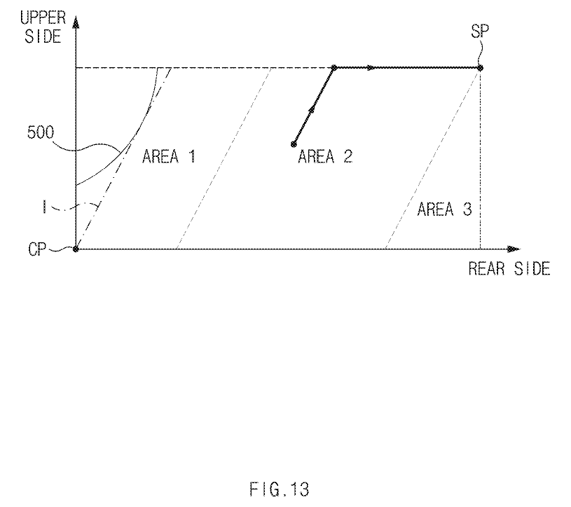

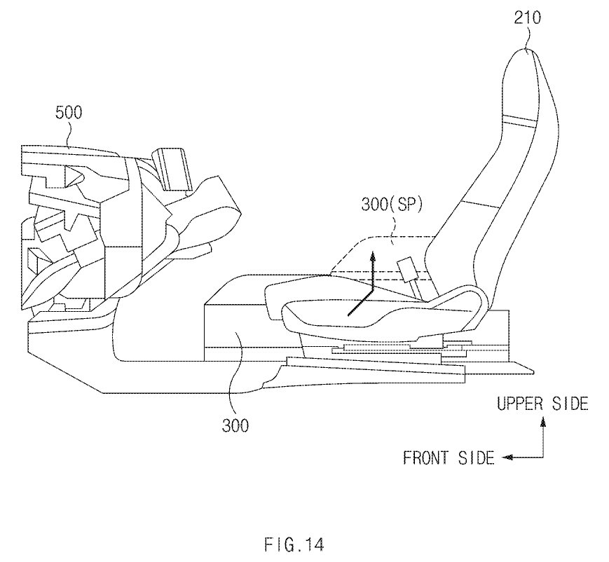

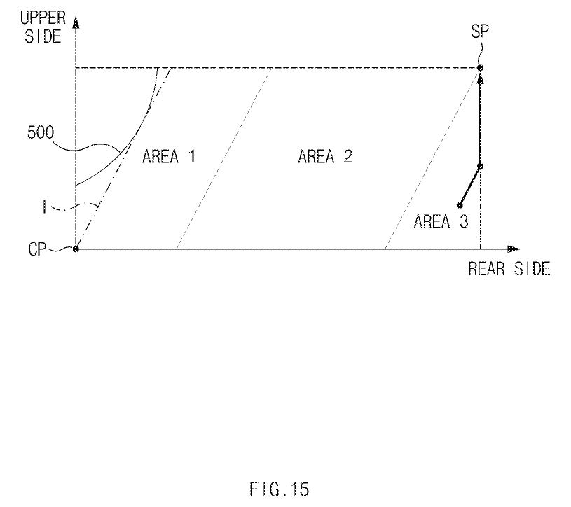

FIG. 1 is a schematic view of an example vehicle. FIG. 2 is a view of example console switches. FIG. 3 is an example flowchart of an example method for controlling a console of a vehicle. FIGS. 4, 5, and 6 are flowcharts for an example method of controlling a console of a vehicle. FIG. 7 is a view illustrating an example of a reference state of a front seat. FIG. 8 is a side view of an example vehicle console that transitions from a standard position to a collapsed position, along with a dashboard module and a front seat. FIG. 9 is a view illustrating a movement path of an example console (e.g., the console as shown in FIG. 8) for a vehicle. FIG. 10 is a side view of an example vehicle console that transitions from a collapsed position to a standard position, along with a dashboard module and a front seat. FIG. 11 is a view illustrating a movement path of an example console (e.g., the console as shown in FIG. 10) for a vehicle. FIG. 12 is a side view of an example vehicle console that transitions from a second area to a standard position, along with a dashboard module and a front seat. FIG. 13 is a view illustrating a movement path of an example console (e.g., the console as shown in FIG. 12) for a vehicle. FIG. 14 is a side view of an example vehicle console that transitions from a third area to a standard position, along with a dashboard module and a front seat. FIG. 15 is a view illustrating a movement path of an example console (e.g., the console as shown in FIG. 14) for a vehicle.

Referring to FIGS. 1 to 15, a vehicle 100 may include a vehicle frame 110 that defines an interior space of the vehicle 100, a seat 200 that is mounted in an interior of the vehicle frame 110, and a console 300 for a vehicle.

Furthermore, as illustrated in FIG. 2, the vehicle 100 may include a console switch 400. The console switch 400 may include a one-touch button 410, an up button 420, a down button 430, a front button 440, and a rear button 450.

The one-touch button 410 may be a button for moving the console 300 for a vehicle that will be described later from any one of a standard position (also referred to as deployed position, unfolded position, etc.) SP and a collapsed position (also referred to as stowed position, folded position, compact position, etc.) CP to the other position at once.

The up button 420 may be a button for raising a height of the console 300 for a vehicle. The down button 430 may be a button for lowering the height of the console 300 for a vehicle, contrary to the up button 420.

That is, the up button 420 may be a button for raising the position of the console 300 for a vehicle, and the down button 430 may be a button for lowering the position of the console 300 for a vehicle.

The front button 440 may be a button for moving the position of the console 300 for a vehicle forward. The rear button 450 may be a button for moving the position of the console 300 for a vehicle rearward, contrary to the front button 440.

A lamp part (e.g., an LED) (not illustrated) may be provided on a lower side of the console switch 400. The lamp part may be provided on a lower side of each of the one-touch button 410, an up button 420, a down button 430, a front button 440, and a rear button 450.

The vehicle 100 may include a body controller (not illustrated) that is electrically connected to the seat for driving of the vehicle 100.

The vehicle 100 may include a controller (not illustrated) that is provided separately from the body controller or provided to be integrated therewith, and is electrically connected to the seat 200, the console 300 for a vehicle, the console switch 400, and the lamp part.

The controller may include a memory and a processor. The memory may include a volatile memory of a static random access memory (S-RAM) and a dynamic random access (D-RAM) for temporarily storing data while electric power is being supplied, and a nonvolatile memory, such as a read only memory (ROM) and an erasable programmable read only memory (EPROM) for storing data even when the supply of the electric power is cut off.

The processor may include various logic circuits and operation circuits, and may process data according to a program provided from the memory and generate a control signal according to a processing result.

The processor may be electrically connected to the one-touch button 410, the up button 420, the down button 430, the front button 440, the rear button 450, the plurality of lamp parts (e.g., lamps), and the console 300 for a vehicle.

The processor may receive signals from the one-touch button 410, the up button 420, the down button 430, the front button (also referred to as forward button) 440, and the rear button (also referred to as backward button or rearward button) 450 to control the plurality of lamp parts and the console 300 for a vehicle.

Referring to FIG. 3, a method for controlling the console of a vehicle may include a gear state identifying operation (S100), an interworking state identifying operation (S200), a seat state identifying operation (S300), a switch inputting operation (S400), and a console position identifying operation (S500).

The gear state identifying operation (S100) may be an operation of identifying a gear state (e.g., gear position) of the vehicle 100 is park (also referred to as a parking state).

The interworking state identifying operation (S200) may be an operation of identifying interworking of the body controller and the seat 200 of the vehicle is off.

In detail, the interlocking state identifying operation (S200) may be an operation of, before the console 300 for a vehicle is moved, identifying that the seat is not in a getting-on/off mode (also referred to as easy entry mode, easy exit mode, easy access mode, seat access mode, ingress and egress mode, ingress and egress assist mode, occupant entry and exit mode, etc.), in which the seat 200 is moved rearward (e.g., all the way to the back or at least a threshold amount to the rear) or the console 300 for a vehicle is moved rearward so that it is convenient when a user who uses the vehicle 100 gets on or off the vehicle; a face-to-face mode, in which the front seat 210 is rotated to face the rear seat 220, is off; and a display part of the vehicle is off, for example, not in a movie mode, in which a movie may be watched through the display part of the vehicle 100.

The seat state identifying operation (S300) may be an operation of identifying whether the seat state of the vehicle 100 is a reference state. Here, as illustrated in FIG. 7, the reference state of the seat state of the vehicle 100 may mean when an angle, by which areas of the pair of front seats 210, which face the front side from positions of seats 200 of the vehicle 100, in which the pair of front seats 210 are parallel to each other, are rotated toward each other, is 3 degrees or less.

Accordingly, the seat state identifying operation (S300) may be an operation that is satisfied when an angle, by which areas of the pair of front seats 210, which face the front side from positions, in which the pair of front seats 210 are parallel to each other, are rotated toward each other, is 3 degrees or less.

The switch inputting operation (S400) may be an operation of receiving a console operation input from the user through the console switch 400. In the switch inputting operation (S400), any one of the one-touch button 410, the up button 420, the down button 430, the front button 440, and the rear button 450 may be input by the user through the console switch 400.

The console position identifying operation (S500) may be an operation of identifying whether the position of the console 300 for a vehicle is located in the standard position SP by identifying a height of the console 300 for a vehicle and a position of the console 300 for a vehicle in the forward/rearward direction (e.g., a longitudinal position of the console 300).

The console position identifying operation (S500) may be performed by an actuator sensor that senses a driving degree of a console actuator motor that drives the console 300 for a vehicle. In this way, the processor may be electrically connected to the actuator sensor, and may receive the position of the console 300 for a vehicle from the actuator sensor.

The console operating operation (S600) may be an operation of, when receiving the console operation input through the switch inputting operation (S400), moving the console 300 for the vehicle between the standard position SP and the collapsed position CP, when i) the gear state (e.g., gear position) identifying operation is satisfied, ii) the interworking state identifying operation is satisfied, and iii) the seat state is the reference state in the seat state identifying operation.

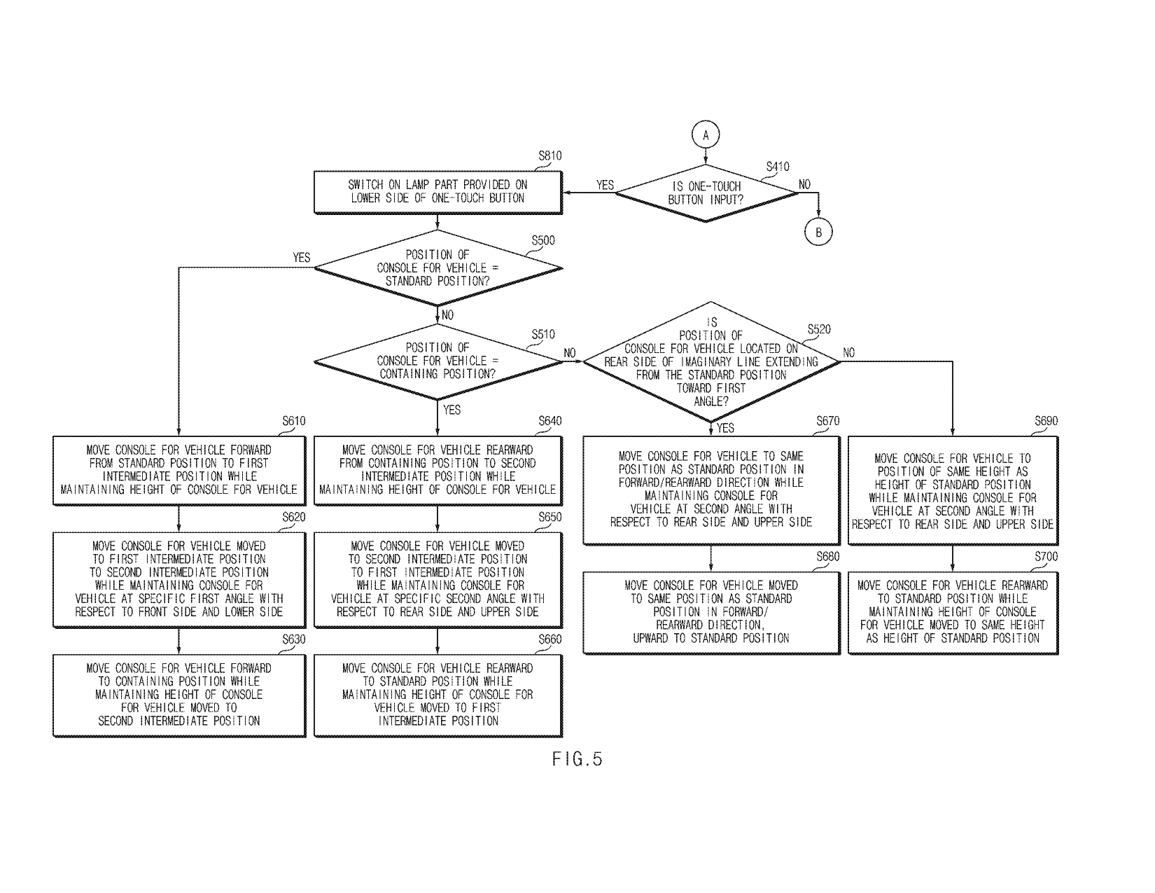

In more detail, referring to FIGS. 4 and 5, in the method for controlling the console 300 for a vehicle, the processor may perform the gear state identifying operation (S100) of identifying whether the gear state of the vehicle 100 is park when the vehicle 100 is started.

When the gear state (e.g., gear position) of the vehicle 100 is park (Yes in S100), the processor may perform the interlocking state identifying operation of identifying whether the console 300 for a vehicle and the seat 200 of the vehicle 100 are not in a getting-on/off mode, the seat 200 of the vehicle 100 is not in a face-to-face mode, and a display part of the vehicle 100 is off.

When the interworking state identifying operation is satisfied (Yes in S200), the processor may be in a state, in which a height of the console 300 for a vehicle may be controlled (S210).

Thereafter, the processor may perform a seat state identifying operation (S300) of determining whether a swivel angle of the front seat 210 is 3 degrees or less. The swivel angle of the front seat 210 in the seat state identifying operation (S300) may mean an angle, by which areas of the pair of front seats 210, which face a front side, are rotated toward each other from positions, in which the front seats 210 are parallel to each other.

When it is identified that the swivel angle of the front seat 210 is 3 degrees or less (Yes in S300), the processor may be in a state, the console 300 for a vehicle with respect to the front and rear sides may be controlled (S310).

Thereafter, the processor may perform the switch inputting operation (S400) of determining whether a console operation input is received from the user through the console switch 400. When it is identified that the console operation input is received from the user through the console switch 400 (Yes in S400) in the switch inputting operation (S400), it may be determined whether which control operation input is received from the console switch 400.

That is, the processor may receive an input of the user through any one of the one-touch button (e.g., touch-sensitive button) 410, the up button 420, the down button 430, and the front button 440, through the console switch 400, in the switch inputting operation (S400).

Meanwhile, the console switch 400 may include a plurality of lamp parts (e.g., an LED) that are provided on a lower side of each of the one-touch button 410, the up button 420, the down button 430, the front button 440, and the rear button 450.

Accordingly, the switch inputting operation (S400) may further include an operation (S810, S820, S830, S840, and S850) of, when any one of the one-touch button 410, the up button 420, the down button 430, the front button 440, and the rear button 450 of the console switch 400 is input, switching on the lamp part provided on a lower side of the input any one of the one-touch button 410, the up button 420, the down button 430, the front button 440, and the rear button 450.

According to the principle, when any one of the one-touch button 410, the up button 420, the down button 430, the front button 440, and the rear button 450 is pressed, the lamp part provided on a lower side of the input button is switched on and the user may identify which button is pressed.

The processor may determine whether the one-touch button 410 is input through the console switch 400 in the switch inputting operation (S400) (S410). When it is identified that the one-touch button 410 is input through the console switch 400 (Yes in S410) in the switch inputting operation (S400), the lamp part provided on a lower side of the one-touch button 410 may be switched on (S810).

Thereafter, the processor may perform the console position identifying operation (S500) of identifying whether the position of the console 300 for a vehicle is located in the standard position SP.

When it is identified that the position of the console 300 for a vehicle is the standard position SP (Yes in S500), the processor may move the console 300 for a vehicle from the standard position SP to the collapsed position CP.

Unlike this, when it is identified that the position of the console 300 for a vehicle is not the standard position SP (No in S500), the processor may determine whether the console 300 for a vehicle is in the collapsed position CP (S510).

That is, the console position identifying operation (S500) may further include an operation of identifying whether the console 300 for a vehicle is located in the collapsed position CP.

When the console 300 for a vehicle is located in the collapsed position CP (Yes in S510), the processor may move the console 300 for a vehicle from the collapsed position CP to the standard position SP.

Referring to FIGS. 8 and 9 together, when the one-touch button is input through the console switch 400 in the switch inputting operation (S400) and it is identified that the console 300 for the vehicle is in the standard position SP in the console position identifying operation (S500), the processor may move the console 300 for the vehicle forward from the standard position SP to a first intermediate position IP1 while maintaining a height of the console 300 for the vehicle (S610), move the console 300 for the vehicle moved to the first intermediate position IP1 to a second intermediate position IP2 while maintaining the console 300 for the vehicle at a first angle with respect to a front side and a lower side (e.g., a lower front corner of the vehicle) (S620), and move the console 300 for the vehicle forward to the collapsed position CP while maintaining the height of the console 300 for the vehicle moved to the second intermediate position IP2 (S630). The first angle may be between a longitudinal axis of the vehicle and a first vector that is directed toward a lower forward direction of the vehicle.

That is, the console operating operation (S600) of the method for controlling the console 300 for a vehicle may include an operation of, when the one-touch button 410 is input through the console switch in the switch inputting operation (S400) and it is identified that the console 300 for the vehicle is in the standard position SP in the console position identifying operation (S500), moving the console 300 for the vehicle forward from the standard position SP to a first intermediate position IP1 while maintaining a height of the console 300 for the vehicle, moving the console 300 for the vehicle moved to the first intermediate position IP1 to a second intermediate position IP2 while maintaining the console 300 for the vehicle at a specific first angle with respect to a front side and a lower side and moving the console 300 for the vehicle forward to the collapsed position CP while maintaining the height of the console 300 for the vehicle moved to the second intermediate position IP2.

Here, the standard position SP of the console 300 for a vehicle may be a position that is disposed between the pair of front seats 210, and the collapsed position CP of the console 300 for a vehicle may be located on a front side of the standard position SP and at a position that is lower than the standard position SP.

In other words, the standard position SP of the console 300 for a vehicle may be located on a rear side of the collapsed position CP of the console 300 for a vehicle and may be located at a position that is higher than the collapsed position CP of the console 300 for a vehicle.

A first angle, by which the console 300 for the vehicle is moved when the console 300 for the vehicle is moved from the first intermediate position IP1 to the second intermediate position IP2, corresponds to an angle facing one direction of an inclination (e.g., slope) of an imaginary tangent “I” at a point protruding most toward a rear side of a portion of a dashboard module (also referred to as a dashboard) 500 of the vehicle, which portion is provided on a lower side of a handle (e.g., steering wheel or steering column).

Furthermore, a horizontal distance “L” between the second intermediate position IP2 and the collapsed position CP of the console 300 for a vehicle is a preset distance, and may be a distance for avoiding contact with the dashboard module 500 when the console 300 for a vehicle is moved from the first intermediate position IP1 to the second intermediate position IP2.

Furthermore, the path illustrated in FIG. 9 may be understood as a path at one point of the console 300 for a vehicle that is moved from the standard position SP to the first intermediate position IP1, the second intermediate position IP2, and the collapsed position CP, which is located a foremost side.

Referring to FIGS. 10 and 11, when the one-touch button 410 is input through the console switch 400 in the switch inputting operation (S400) and it is identified that the console 300 for the vehicle is not in the standard position SP but in the collapsed position CP in the console position identifying operation (Yes in S510), the processor may move the console 300 for the vehicle rearward from the collapsed position CP to a second intermediate position IP2 while maintaining the height of the console 300 for the vehicle (S640), move the console 300 for the vehicle moved to the second intermediate position IP2 to the first intermediate position IP1 while maintaining the console 300 for the vehicle at a second angle with respect to a rear side and an upper side (e.g., an upper rear corner of the vehicle) (S650), and move the console 300 for the vehicle rearward to the standard position SP while maintaining the height of the console 300 for the vehicle moved to the first intermediate position IP1 (S660). The second angle may be between a longitudinal axis of the vehicle and a second vector that is directed toward an upper rear direction.

That is, the console operating operation (S600) of the method for controlling the console 300 for a vehicle may include an operation of, when the one-touch button 410 is input through the console switch 400 in the switch inputting operation (S400) and it is identified that the console 300 for the vehicle is in the collapsed position CP in the console position identifying operation (Yes in S510), moving the console 300 for the vehicle rearward from the collapsed position CP to a second intermediate position IP2 while maintaining the height of the console 300 for the vehicle, moving the console 300 for the vehicle moved to the second intermediate position IP2 to the first intermediate position IP1 while maintaining the console 300 for the vehicle at a specific second angle with respect to a rear side and an upper side; and moving the console 300 for the vehicle rearward to the standard position SP while maintaining the height of the console 300 for the vehicle moved to the first intermediate position IP1.

Here, a movement path from the collapsed position CP to the standard position SP of the console 300 for a vehicle may be in an opposite direction to that of the movement path from the standard position SP to the collapsed position CP of the above-described console 300 for a vehicle.

That is, the path, in which the console 300 for a vehicle is moved when it is moved from the second intermediate position IP2 to the first intermediate position IP1 of the console 300 for a vehicle, may be a path that is in an opposite direction to that of the path, in which the console 300 for a vehicle is moved when it is moved from the first intermediate position IP1 to the second intermediate position IP2 of the console 300 for a vehicle.

Accordingly, the second angle of the console 300 for a vehicle may also correspond to an angle that faces an opposite direction of the inclination of the imaginary tangent “I” at a point that protrudes most toward a rear side of a portion of the dashboard module 500, which is provided on a lower side of the handle. In other words, the second angle may be symmetrical to the first angle with respect to a longitudinal axis of the vehicle. The first vector and the second vector may be antiparallel vectors.

Furthermore, a horizontal distance “L” between the collapsed position CP and the second intermediate position IP1 of the console 300 for a vehicle may be a distance for avoiding contact with the dashboard module 500 when the console 300 for a vehicle is moved from the second intermediate position IP2 to the first intermediate position IP1.

Furthermore, the path illustrated in FIG. 11 may be understood as a path at one point of the console 300 for a vehicle that is moved from the collapsed position CP to the second intermediate position IP2, the first intermediate position IP1, and the standard position SP, which is located a foremost side.

As described above, the console operating operation (S600) may include an operation of moving the console 300 for a vehicle from the standard position SP to the collapsed position CP i) when the one-touch button 410 is input through the console switch 400 in the switch inputting operation (S400) and it is identified that the console 300 for a vehicle is in the standard position SP in the console position identifying operation (S500), and moving the console 300 for a vehicle from the collapsed position CP to the standard position SP ii) when the one-touch button 410 is input through the console switch 400 in the switch inputting operation (S400) and it is identified that the console 300 for a vehicle is in the collapsed position CP in the console position identifying operation (S500).

Meanwhile, when the position of the console 300 for a vehicle is not the standard position SP (No in S500) and the position of the console 300 for a vehicle is not the collapsed position CP either (No in S510), it may be determined whether the position of the console 300 for a vehicle is located in any one of a second area (area 2) or a third area (area 3) (S520).

That is, the console position identifying operation (S500) may further include an operation (S520) of determining whether the position of the console 300 for a vehicle is located on a rear side of an imaginary line that extends from the standard position SP toward the first angle when the position of the console 300 for a vehicle is not the standard position SP (No in S500) and the position of the console 300 for a vehicle is not the collapsed position CP either (No in S510).

When it is identified that the position of the console 300 for a vehicle is located on a front side of the imaginary line that extends from the standard position SP toward the first angle and is located in the second area (area 2) (No in S520), as illustrated in FIGS. 12 and 13, the processor may move the console 300 for a vehicle to a position of the same height as the standard position SP while maintaining the second angle with respect to the rear side and the upper side (S690), and may move the console 300 for a vehicle moved to the position of the same height as the height of the standard position SP while maintaining the height of the console 300 for a vehicle (S700).

That is, the console operating operation (S600) may further include an operation of, when the one-touch button 410 is input through the console switch 400 in the switch inputting operation (S400), and it is identified that a position of the console 300 for the vehicle is located on a front side of the imaginary line that extends from the standard position SP at the first angle in the console position identifying operation (S500), moving the console 300 for the vehicle to a position of the same height as a height of the standard position SP while maintaining the console 300 for the vehicle at the second angle with respect to a rear side and an upper side (S690), and moving the console 300 for the vehicle rearward to the standard position SP while maintaining the height of the console 300 for the vehicle moved to the same height as the height of the standard position (S700).

Unlike this, when it is identified that the position of the console 300 for a vehicle is located on a rear side of the imaginary line that extends from the standard position SP toward the first angle and is located in the third area (area 3) (Yes in S520), as illustrated in FIGS. 14 and 15, the processor may move the console 300 for a vehicle to the same position as the standard position SP in the forward/rearward direction while maintaining the second angle with respect to the rear side and the upper side (S670), and may move the console 300 for a vehicle moved to the same position as the standard position SP in the forward/rearward direction, upward to the standard position SP (S680).

That is, the console operating operation (S600) may further include an operation of, when the one-touch button 410 is input through the console switch 400 in the switch inputting operation (S400), and it is identified that a position of the console 300 for the vehicle is located on a rear side of an imaginary line that extends from the standard position SP at the first angle in the console position identifying operation (S500) (Yes in S520), moving the console 300 for the vehicle to the same position as the standard position SP in the forward/rearward direction while maintaining the console 300 for the vehicle at the second angle with respect to the rear side and the upper side (S670), and moving the console 300 for the vehicle moved to the same position as the standard position SP with respect to the forward/rearward direction, upward to the standard position SP (S680).

According to the above-described principle, when the one-touch button 410 is received, the console 300 for a vehicle may be moved from any one of the standard position SP and the collapsed position CP to the other one.

Then, the console 300 for a vehicle may be located in the standard position SP when the vehicle 100 is driven, and may be located in the collapsed position CP when the vehicle 100 is stopped and the front seat 210 is in the reference state.

Accordingly, when the console 300 for a vehicle is located in the collapsed position CP, a utility of the space between the front seats 210 may be increased so that convenience of the user may be improved. In particular, with the development of autonomous vehicles, the spatial utility of the passengers may be maximized when the front seat 210 is rotated such that the front seat 210 and the rear seat 220 face each other.

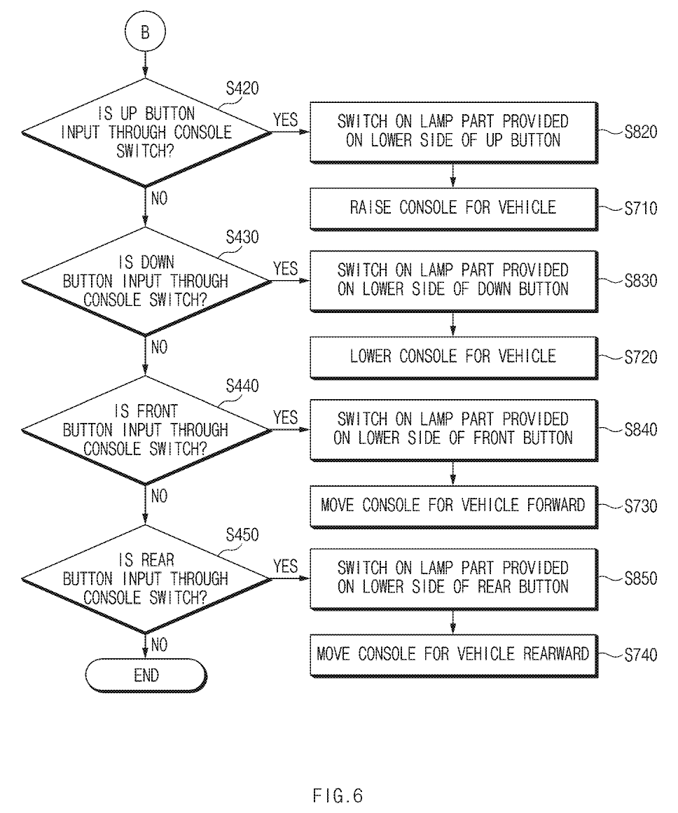

Meanwhile, according to the method for controlling the console 300 for a vehicle, when no one-touch button 410 is input through the console switch 400 (No in S410) in the switch inputting operation (S400), as illustrated in FIG. 6, it may be determined whether any one of the up button 420, the down button 430, the front button 440, and the rear button 450 is input.

As an example, in the switch inputting operation (S400), when it is identified that no one-touch button 410 is input (No in S410), it may be determined whether the up button 420 is input through the console switch 400 (S420).

When it is identified that the up button 420 is input through the console switch 400 (Yes in S420), the processor may switch on the lamp part provided on a lower side of the up button (S820), and may raise the console 300 for a vehicle (S710).

That is, the switch inputting operation (S400) may further include an operation (S820) of switching on the lamp part provided on a lower side of the up button 420, and the console operating operation (S600) may further include an operation (S710) of raising the console 300 for a vehicle when the up button 420 is input in the switch inputting operation (S400).

When it is identified that no up button 420 is input through the console switch 400 (No in S420), it may be identified whether the down button 430 is input through the console switch 400 (S430).

When it is identified that the down button 430 is input through the console switch 400 (Yes in S430), the processor may switch on the lamp part provided on a lower side of the down button (S830), and may lower the console 300 for a vehicle (S720).

That is, the switch inputting operation (S400) may further include an operation (S830) of switching on the lamp part provided on a lower side of the down button 430, and the console operating operation (S600) may further include an operation (S720) of lowering the console 300 for a vehicle when the down button 430 is input in the switch inputting operation (S400).

When it is identified that no down button 430 is input through the console switch 400 (No in S430), it may be identified whether the front button 430 is input through the console switch 400 (S440).

When it is identified that the front button 440 is input through the console switch 400 (Yes in S440), the processor may switch on the lamp part provided on a lower side of the front button (S840), and may move the console 300 for a vehicle forward (S730).

That is, the switch inputting operation (S400) may further include an operation (S840) of switching on the lamp part provided on a lower side of the front button 440, and the console operating operation (S600) may further include an operation (S730) of moving the console 300 for a vehicle forward when the front button 440 is input in the switch inputting operation (S400).

When it is identified that no front button 440 is input through the console switch 400 (No in S440), it may be identified whether the rear button 450 is input through the console switch 400 (S450).

When it is identified that the rear button 450 is input through the console switch 400 (Yes in S450), the processor may switch on the lamp part provided on a lower side of the rear button (S850), and may move the console 300 for a vehicle rearward (S740).

That is, the switch inputting operation (S400) may further include an operation (S850) of switching on the lamp part provided on a lower side of the rear button 440, and the console operating operation (S600) may further include an operation (S740) of moving the console 300 for a vehicle rearward when the rear button 440 is input in the switch inputting operation (S400).

Meanwhile, when it is identified that no one-touch button 410 is input (No in S410) in the switch inputting operation (S400), the sequence of the operations of identifying whether the up button 420, the down button 430, the front button 440, and the rear button 450 are input is not limited to FIG. 6, and the operations may be progressed independently.

Furthermore, when it is identified that any one of the up button 420, the down button 430, the front button 440, and the rear button 450 is input in the switch inputting operation (S400), the processor may perform a separate control for the console 300 for a vehicle.

When any one of the up button 420, the down button 430, the front button 440, and the rear button 450 is input, the console position identifying operation (S500) of recognizing the position of the console 300 for a vehicle may be performed again.

When it is identified that the position of the console 300 for a vehicle reaches the same height as the height of the standard position SP in the console position identifying operation (S500), and the up button 420 is input in the switch inputting operation (S400), the processor may perform a control to prevent the height of the console 300 for a vehicle from being raised more.

That is, the console operating operation (S600) may further include an operation of performing a control to prevent the height of the console 300 for the vehicle from being further raised when it is identified that the position of the console 300 for the vehicle reaches the same height as a height of the standard position SP in the console position identifying operation (S500), and the up button 420 is input in the switch inputting operation (S400).

When it is identified that the position of the console 300 for a vehicle reaches the same height as the height of the collapsed position CP in the console position identifying operation (S500), and the down button 420 is input in the switch inputting operation (S400), the processor may perform a control to prevent the height of the console 300 for a vehicle from being lowered more.

That is, the console operating operation (S600) may further include an operation of performing a control to prevent the height of the console 300 for the vehicle from being further lowered when it is identified that the position of the console 300 for the vehicle reaches the same height as a height of the collapsed position CP in the console position identifying operation (S500), and the down button 430 is input in the switch inputting operation (S400).

Furthermore, when it is identified that the position of the console 300 for a vehicle reaches the same position as the position of the collapsed position CP in the forward/rearward direction in the console position identifying operation (S500), and the front button 440 is input in the switch inputting operation (S400), the processor may perform a control to prevent the console 300 for a vehicle from being moved forward.

That is, the console operating operation (S600) may further include an operation of performing a control to prevent the console 300 for the vehicle from being moved forward when it is identified that the position of the console 300 for the vehicle reaches the same position as a position of the collapsed position CP in the console position identifying operation (S500), and the front button 430 is input in the switch inputting operation (S400).

Furthermore, when it is identified that the position of the console 300 for a vehicle reaches the same position as the position of the standard position SP in the forward/rearward direction in the console position identifying operation (S500), and the rear button 450 is input in the switch inputting operation (S400), the processor may perform a control to prevent the console 300 for a vehicle from being moved rearward.

That is, the console operating operation (S600) may further include an operation of performing a control to prevent the console 300 for the vehicle from being moved rearward when it is identified that the position of the console 300 for the vehicle reaches the same position as a position of the standard position SP in the forward/rearward direction in the console position identifying operation (S500), and the rear button 450 is input in the switch inputting operation (S400).

According to the principle, the console 300 for a vehicle may be prevented from being moved forward more than the collapsed position CP, may be prevented from being moved rearward more than the standard position SP, may be prevented from being lowered more than the height of the collapsed position CP, and may be prevented from being raised more than the height of the standard position SP.

Accordingly, because an area, in which the console 300 for a vehicle is movable, is limited while the console 300 for a vehicle is movable in the forward/rearward direction or the upward/downward direction, the console 300 for a vehicle may be prevented from being damaged.

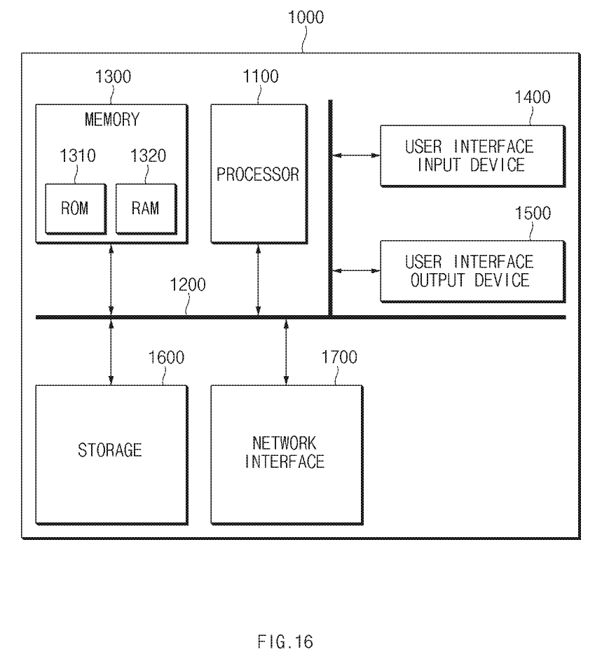

FIG. 16 shows an example computing system (e.g., a computing device of a vehicle or any other apparatus). One or more controllers, processors, etc. described herein may be implemented by the computing system or may be implemented in the computing system.

A computing system (also referred to as a computer, a computing device, etc.) 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable read-only memory (EPROM), an electrically erasable and programmable read-only memory (EEPROM), a register, a hard disk drive, a removable disc, or a compact disc read-only memory (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an aspect of the present disclosure, a method for controlling a console for a vehicle may include a gear state identifying operation of identifying whether a gear state of the vehicle is a parking state, an interworking state identifying operation of identifying whether a state of a seat of the vehicle is not in a getting-on/off mode, the seat of the vehicle is not in a face-to-face mode, and a display part of the vehicle is off, a seat state identifying operation of identifying whether a seat state of the vehicle is a reference state, a switch inputting operation of receiving a console operation input from a user through a console switch, and a console operating operation of, when receiving the console operation input through the switch inputting operation, moving the console for the vehicle between a standard position and a containing position, when i) the gear state identifying operation is satisfied, ii) the interworking state identifying operation is satisfied, and iii) the seat state is the reference state in the seat state identifying operation.

The standard position of the console for the vehicle may be located on a rear side of the containing position of the console for the vehicle and is located at a higher position than the containing position of the console for the vehicle.

The method may further include a console position identifying operation of identifying whether a position of the console for the vehicle is located in the standard position by identifying a height of the console for the vehicle and a position of the console for the vehicle with respect to a forward/rearward direction.

The console switch may include a one-touch button that moves the console for the vehicle from any one to the other one of the standard position of the console for the vehicle and the containing position of the console for the vehicle, and the console operating operation may include moving the console for the vehicle from the standard position to the containing position when the one-touch button is input through the console switch in the switch inputting operation and it is identified that the console for the vehicle is in the standard position in the console position identifying operation, and moving the console for the vehicle from the containing position to the standard position when the one-touch button is input through the console switch in the switch inputting operation and it is identified that the console for the vehicle is in the containing position in the console position identifying operation.

The console operating operation may include, when the one-touch button is input through the console switch in the switch inputting operation and it is identified that the console for the vehicle is in the standard position in the console position identifying operation, moving the console for the vehicle forward from the standard position to a first intermediate position while maintaining a height of the console for the vehicle, moving the console for the vehicle moved to the first intermediate position to a second intermediate position while maintaining the console for the vehicle at a specific first angle with respect to a front side and a lower side, and moving the console for the vehicle forward to the containing position while maintaining the height of the console for the vehicle moved to the second intermediate position.

The first angle, by which the console for the vehicle is moved when the console for the vehicle is moved from the first intermediate position to the second intermediate position, may correspond to an angle facing one direction of an inclination of an imaginary tangent at a point protruding most toward a rear side of a portion of a dashboard module of the vehicle, which portion is provided on a lower side of a handle.

The console operating operation may include, when the one-touch button is input through the console switch in the switch inputting operation and it is identified that the console for the vehicle is in the containing position in the console position identifying operation, moving the console for the vehicle rearward from the containing position to the second intermediate position while maintaining the height of the console for the vehicle, moving the console for the vehicle moved to the second intermediate position to the first intermediate position while maintaining the console for the vehicle at a specific second angle with respect to a rear side and an upper side, and moving the console for the vehicle rearward to the standard position while maintaining the height of the console for the vehicle moved to the first intermediate position.

The first angle, by which the console for the vehicle is moved when the console for the vehicle is moved from the first intermediate position to the second intermediate position, may correspond to an angle facing one direction of an inclination of an imaginary tangent at a point protruding most toward a rear side of a portion of a dashboard module of the vehicle, which portion is provided on a lower side of a handle, and the second angle, by which the console for the vehicle is moved when the console for the vehicle is moved from the second intermediate position to the first intermediate position, may correspond to an angle facing an opposite direction of an inclination of an imaginary tangent at a point protruding most toward a rear side of a portion of a dashboard of the vehicle, which portion is provided on a lower side of a handle.

The console operating operation further may include, when the one-touch button is input through the console switch in the switch inputting operation, and it is identified that a position of the console for the vehicle is located on a front side of an imaginary line extending from the standard position at the first angle in the console position identifying operation, moving the console for the vehicle to a position of the same height as a height of the standard position while maintaining the console for the vehicle at the second angle with respect to a rear side and an upper side, and moving the console for the vehicle rearward to the standard position while maintaining the height of the console for the vehicle moved to the same height as the height of the standard position.

The console operating operation may include, when the one-touch button is input through the console switch in the switch inputting operation, and it is identified that a position of the console for the vehicle is located on a rear side of an imaginary line extending from the standard position toward the first angle in the console position identifying operation, moving the console for the vehicle to the same position as that of the standard position in a forward/rearward direction while maintaining the console for the vehicle at the second angle with respect to the rear side and the upper side, and moving the console for the vehicle moved to the same position as the standard position with respect to the forward/rearward direction, upward to the standard position.

The console switch further may include an up button that raises a position of the console for the vehicle and a down switch that lowers the position of the console for the vehicle, and the console operating operation further may include i) raising the console for the vehicle when the up button is input in the switch inputting operation, and ii) lowering the console for the vehicle when the down button is input in the switch inputting operation.

The console operating operation further may include performing a control to prevent the height of the console for the vehicle from being further raised when it is identified that the position of the console for the vehicle reaches the same height as a height of the standard position in the console position identifying operation, and the up button is input in the switch inputting operation, and performing a control to prevent the height of the console for the vehicle from being lowered further when it is identified that the position of the console for the vehicle reaches the same height as a height of the containing position in the console position identifying operation, and the down button is input in the switch inputting operation.

The console switch further may include a front button that moves the position of the console for the vehicle forward, and a rear button that moves the position of the console for the vehicle rearward, and the console operating operation further may include i) moving the console for the vehicle forward when the front button is input in the switch inputting operation, and ii) moving the console for the vehicle rearward when the rear button is input in the switch inputting operation.

The console operating operation further may include performing a control to prevent the console for the vehicle from being moved forward when it is identified that the position of the console for the vehicle reaches the same position as a position of the containing position in a forward/rearward direction in the console position identifying operation, and the front button is input in the switch inputting operation, and performing a control to prevent the console for the vehicle from being moved rearward when it is identified that the position of the console for the vehicle reaches the same position as a position of the standard position in the forward/rearward direction, and the rear button is input in the switch inputting operation.

The reference state of the seat state may correspond to when an angle, by which areas of the pair of front seats, which face the front side from positions of seats of the vehicle, in which the pair of front seats are parallel to each other, are rotated toward each other, is 3 degrees or less.

The console switch may include an up button that raises the position of the console for the vehicle, a down button that lowers the position of the console for the vehicle, a front button that moves the position of the console for the vehicle forward, a rear button that moves the position of the console for the vehicle rearward, and a plurality of lamp parts provided on a lower side of each of the one-touch button, the up button, the down button, the front button, and the rear button, and the switch inputting operation further may include, when any one of the one-touch button, the up button, the down button, the front button, and the rear button of the console switch is input, switching on the lamp part provided on a lower side of the input any one of the one-touch button, the up button, the down button, the front button, and the rear button.

According to the present technology, because the position of the console for a vehicle may be changed according to the method for controlling the console for a vehicle, the spatial utility in the interior of the vehicle may be improved.

In addition, according to the present technology, because a detailed position of the console for a vehicle may be changed by the user through the console switch, convenience of the user may be improved.

Furthermore, according to the present technology, because the console for a vehicle may be moved from any one of the standard position and the containing position to the other one through the one-touch button, convenience of the user may be improved.

Besides, a variety of effects directly or indirectly understood through the present disclosure may be provided.

The above description is merely an example of the technical idea of the present disclosure, and various modifications and variations may be made by one skilled in the art without departing from the essential characteristic of the present disclosure.

Accordingly, the example embodiment(s) of the present disclosure are intended not to limit but to explain the technical idea of the present disclosure, and the scope and spirit of the present disclosure is not limited by the example embodiment(s) as described herein. The scope of protection of the present disclosure should be construed by the attached claims, and all equivalents thereof should be construed as being included within the scope of the present disclosure.

What is claimed is:

1. A method performed by an apparatus of a vehicle, the method comprising:
receiving, via a switch on a console of the vehicle, a console operation input; and
controlling the console to move, between a deployed position and a stowed position, based on the console operation input and based on:
a gear position of the vehicle being a park position,
a seat of the vehicle not being in an ingress and egress assist mode,
the seat not being in a face-to-face mode, in which the seat is rotated to face another seat of the vehicle, and
a display of the vehicle being turned off.

2. The method of claim 1, wherein the deployed position of the console is more rearward and higher relative to the stowed position of the console.

3. The method of claim 1, further comprising:
determining, based on a height of the console and a longitudinal position of the console, whether the console is in the deployed position.

4. The method of claim 3, wherein the switch comprises a touch-sensitive button configured to control the console to move from one of the deployed position or the stowed position to another one of the deployed position or the stowed position, and
wherein the controlling of the console comprises one of:
controlling, based on the console operation input via the touch-sensitive button being received and the console being in the deployed position, the console to move from the deployed position to the stowed position; or
controlling, based on the console operation input via the touch-sensitive button being received and the console being in the stowed position, the console to move from the stowed position to the deployed position.

5. The method of claim 1, wherein the controlling of the console comprises:
controlling, based on the console operation input via the touch-sensitive button being received and the console being in the deployed position, the console to move forward from the deployed position to a first intermediate position while maintaining a first height of the console for the vehicle;
controlling the console to move from the first intermediate position to a second intermediate position while maintaining the console at a first angle, wherein the first angle is between a longitudinal axis of the vehicle and a first vector directed toward a lower forward direction of the vehicle; and
controlling the console to move from the second intermediate position to the stowed position while maintaining a second height of the console.

6. The method of claim 5, wherein the first angle corresponds to an angle of a slope of a tangent line touching a surface of a dashboard module and extending from a point of the stowed position located below the dashboard module.

7. The method of claim 5, wherein the controlling of the console comprises:
controlling, based on the console operation input being received and the console being in the stowed position, the console to move rearward from the stowed position to the second intermediate position while maintaining the second height of the console;
controlling the console to move from the second intermediate position to the first intermediate position while maintaining the console at a second angle, wherein the second angle is between the longitudinal axis of the vehicle and a second vector directed toward an upper rear direction; and
controlling the console to move rearward from the first intermediate position to the deployed position while maintaining the first height of the console.

8. The method of claim 7, wherein the first vector and the second vector are antiparallel vectors.

9. The method of claim 8, wherein the controlling of the console comprises:
controlling, based on the console operation input being received and the console being located in front of an imaginary line that extends from the deployed position at the first angle, the console to move to a third intermediate position having a same height as the deployed position while maintaining the console at the second angle with respect to the upper rear direction; and
controlling the console to move rearward from the third intermediate position to the deployed position while maintaining the console at the first height.

10. The method of claim 9, wherein the controlling of the console comprises:
controlling, based on the console operation input being received and the console being located in rear of the imaginary line that extends from the deployed position at the first angle, the console to move to a fourth intermediate position while maintaining the console at the second angle with respect to the upper rear direction; and
controlling the console to move upward from the fourth intermediate position to the deployed position.

11. The method of claim 1, wherein the switch comprise an up button and a down button, and
wherein the controlling of the console comprises one of:
controlling, based on the up button being pushed, the console to move up; or
controlling, based on the down button being pushed, the console to move down.

12. The method of claim 11, wherein the controlling of the console further comprises:
preventing, based on the up button being pushed and the console reaching a same height as the deployed position, the console from moving any further up; or
preventing, based on the down button being pushed and the console reaching a same height as the stowed position, the console from moving any further down.

13. The method of claim 1, wherein the switch comprises a forward button and a rearward button, and
wherein the controlling of the console comprises one of:
controlling, based on the forward button being pushed, the console to move forward; or
controlling, based on the rearward button being pushed, the console to move rearward.

14. The method of claim 13, wherein the controlling of the console further comprises:
preventing, based on the forward button being pushed and the console reaching a same longitudinal position as the stowed position, the console from moving any further forward; or
preventing, based on the rearward button being pushed and the console reaching a same longitudinal position as the deployed position, the console from moving any further rearward.

15. The method of claim 1, wherein the controlling of the console comprises:
controlling the console to move further based on:
each of a pair of front seats of the vehicle having a swivel angle, relative to a front-facing longitudinal direction of the vehicle, of 3 degrees or less.

16. The method of claim 1, wherein the switch comprises:
an up button configured to control the console to move up;
a down button configured to control the console to move down;
a forward button configured to control the console to move forward;
a rearward button configured control the console to move rearward; and
a plurality of lamps, each of the plurality of lamps provided on a lower portion of each of the up button, the down button, the forward button, and the rearward button, and
wherein the controlling of the console comprises:
controlling, based on one of the up button, the down button, the forward button, or the rearward button being pushed, a corresponding lamp of the plurality of lamps to switch on.

17. An apparatus of a vehicle, the apparatus comprising:
a console comprising a switch configured to receive a console operation input; and
control circuitry configured to:
control the console to move, between a deployed position and a stowed position, based on the console operation input and based on:
a gear position of the vehicle being a parking position,
a seat of the vehicle not being in an ingress and egress assist mode,
the seat not being in a face-to-face mode, in which the seat is rotated to face another seat of the vehicle, and
a display of the vehicle being turned off.

18. The apparatus of claim 17, wherein the deployed position of the console is more rearward and higher relative to the stowed position of the console.

19. The apparatus of claim 17, wherein the control circuitry is configured to:
determine, based on a height of the console and a longitudinal position of the console, whether the console is in the deployed position.
